(19) United States
(12) Patent Application Publication
(10) Pub. No.: US 2013/0149567 A1
(43) Pub. Date: Jun. 13, 2013

(54) LITHIUM ION BATTERY WITH AMORPHOUS ELECTRODE MATERIALS

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/806,134

(22) PCT Filed: May 17, 2011
(86) PCT No.: PCT/EP11/02450

§ 371 Date: Mar. 1, 2013

(30) Foreign Application Priority Data
Jun. 21, 2010 (DE) 10 2010 024 479.1

(51) Int. Cl. H01M 2/16; H01M 4/13

(52) U.S. Cl. CPC H01M 2/162; H01M 4/13
USPC 429/50; 429/231.95; 429/218.1; 429/231.1; 429/225; 429/228; 429/231.5; 429/224; 429/223; 429/231.3; 429/221; 429/231.8; 429/144

(57) ABSTRACT

Lithium-ion battery comprising: (a) a positive electrode comprising an amorphous chalcogenide which comprises lithium ions or which can conduct lithium ions; (b) a negative electrode; (c) a separator between the positive electrode and the negative electrode, wherein the separator comprises a non-woven material composed of fibres, preferably polymer fibres; (d) a non-aqueous electrolyte.

The present invention relates to a rechargeable lithium ion battery having a positive electrode comprising at least one amorphous chalcogenide, particularly an oxide, which comprises lithium ions or which can conduct lithium ions.

Due to their high energy density and high capacity as energy storage devices, secondary batteries (rechargeable batteries) can be used for portable information apparatus. They are also used in tools, electrically operated automobiles and hybrid drive automobiles. High demands are placed on the batteries in terms of electrical capacity and energy density. They need to remain stable particularly during charging and discharging, i.e. experience the lowest possible loss of electrical capacity. In addition, they should also be quickly rechargeable. Fast recharging is particularly desirable when used in electrically operated automobiles so as to improve the operational capability of such automobiles.

WO 99/59218 discloses a secondary battery having two electrodes connected together by an electrolyte, wherein the active material in at least one of the electrodes comprises an oxide or a chalcogenide or a lithium-containing oxide or chalcogenide of transition metals. For example, the negative electrode can contain amorphous or crystalline lithium manganate. Insulating ceramic, glass or polypropylene is cited as the separator.

Using an anode of a lithium metal and a cathode of a vitreous (amorphous) lithium iron phosphate to increase the charging rate of a battery is also already known (Kang, B. and Ceder, G., “Battery materials for ultrafast charging and discharging,” Nature, Vol. 458, pages 190-193 (Mar. 12, 2009)).

The object of the present invention is the providing of a rechargeable lithium ion battery having improved charging properties. The charging rate in particular is to be increased compared to conventional lithium ion batteries.

This object is solved by a rechargeable lithium ion battery which comprises:
(a) a positive electrode comprising at least one amorphous chalcogenide which comprises lithium ions or which can conduct lithium ions;
(b) a negative electrode;
(c) a separator between the positive and the negative electrode, wherein the separator comprises a non-woven material composed of fibers;
(d) a non-aqueous electrolyte.

In one embodiment of the battery, the amorphous chalcogenide is
a lithium-containing compound of one or more of the chalcogen elements of oxygen, sulfur, selenium and tellurium; or
a lithium-containing compound of one or more of the chalcogen elements of oxygen, sulfur, selenium and tellurium with one or more metals, transition metals, arsenic, germanium, phosphorus, antimony, boron, in particular lead, aluminum, gallium, indium, titanium; or
a compound of one or more of the chalcogen elements of oxygen, sulfur, selenium and tellurium with one or more metals, transition metals, arsenic, germanium, phosphorus, antimony, boron, in particular lead, aluminum, gallium, indium, titanium, able to conduct lithium ions.

In one embodiment of the battery, the elements contained in the amorphous chalcogenide are not in a stoichiometric ratio.

In one embodiment of the battery, the amorphous chalcogenide is selected from a lithium phosphate; lithium phosphate containing a transition metal; a mixed oxide of lithium oxide and one or more transition metal oxides; a transition metal oxide able to conduct lithium ions; or a mixture of two or more thereof.

In one embodiment of the battery, the amorphous chalcogenide is provided as a coating on the positive electrode (a).

In one embodiment of the battery, in addition to the amorphous chalcogenide, the positive electrode (a) comprises a crystalline oxide comprising lithium ions or which can conduct lithium ions.

In one embodiment of the battery, the crystalline chalcogenide is selected from: lithium manganate, lithium nickelate, lithium cobaltate or a mixed oxide of two or more of these oxides; lithium iron phosphate.

In one embodiment of the battery, the negative electrode (b) comprises carbon and/or lithium titanate.

In one embodiment of the battery, in addition to the amorphous chalcogenide, the positive electrode comprises sulfur and/or a lithium sulfide and the negative electrode comprises lithium metal or a lithium alloy.

In one embodiment of the battery, the fibers of the non-woven material are polymer fibers.

In one embodiment of the battery, the polymer fibers are selected from the group of polymers consisting of polyester, polyolefin, polyamide, polyacrylonitrile, polyimide, polyetherimide, polysulfone, polyamidimide, polyether, polyphenylensulfide, aramid or mixtures of two or more of these polymers.

In one embodiment of the battery, the polymer fibers comprise a polyethylene terephthalate.

In one embodiment of the battery, a porous inorganic coating able to conduct lithium ions is provided in the non-woven material and/or on one or both sides of the non-woven material.

In one embodiment of the battery, the separator (c) is composed of a carrier which is at least partially permeable to material and which does not conduct electrons or only poorly conducts electrons, wherein the carrier is coated on at least one side with an inorganic material, wherein an inorganic material is used as the carrier at least partially permeable to material which is formed as a non-woven fibrous material, wherein the inorganic material is in the form of polymer fibers, preferably polymer fibers of polyethylene terephthalate (PET), wherein the non-woven material is coated with an inorganic ion-conducting material which preferably conducts ions in a temperature range of from −40 to 200° C., wherein the inorganic ion-conducting material preferentially comprises a compound from the group of the oxides, phosphates, sulfates, titanates, silicates, aluminosilicates having at least one of the elements of zirconium, aluminum, lithium, particularly preferentially zirconium oxide, wherein the inorganic ion-conducting material preferentially exhibits particles having a maximum diameter of less than 100 nm.

In one embodiment of the battery, a polymer layer designed as a film or a non-woven material is disposed between the separator (c) and the positive electrode (a) and/or between the separator (c) and the negative electrode (b).

In one embodiment of the battery, the polymer layer contains a polyolefin.

In one embodiment of the battery, the electrolyte comprises an organic solvent and a conducting salt.

In one embodiment of the battery, the organic solvent is selected from among ethylene carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, cyclopentanone, sulfolane, dimethyl sulfoxide, 3-methyl-1,3-oxazolidine-2-one, y-butyrolactone, 1,2-diethoxymethane, tetrahydrofuran, 2-methyltetrahydrofuran, 1,3-dioxolane, methyl acetate, ethyl acetate, nitromethane, 1,3-propansultone and mixtures of two or more of these solvents.

In one embodiment of the battery, the conducting salt is selected from LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₊₁)₂ or LiC(SO₂CₓF₂ₓ₊₁)₃ at 0≦x≦8, Li[(C₂O₄)₂B], or mixtures of two or more of these salts.

In one embodiment of the battery, cooling means are provided in or on the battery.

The invention also relates to a lithium ion battery comprising:
(a) a positive electrode comprising sulfur and/or a lithium sulfide as well as at least one amorphous chalcogenide which comprises lithium ions or which can conduct lithium ions;
(b) a negative electrode comprising lithium metal or a lithium alloy;
(c) a separator between the positive and the negative electrode, wherein the separator comprises a porous membrane, a ceramic electrolyte separator, a glass electrolyte separator or a polymer electrolyte;
(d) a non-aqueous electrolyte.

The invention also relates to the use of the lithium ion battery in the supplying of energy to portable information apparatus, tools, electrically operated automobiles and hybrid drive automobiles.

As used herein, the term “lithium ion battery” encompasses such terms as “lithium ion secon-dary battery,” “lithium ion accumulator,” “lithium ion cell,” “lithium sulfur battery,” “lithium sulfide battery,” “lithium sulfur accumulator,” “lithium sulfur cell” and the like. This means that the term “lithium ion battery” is used as a generic term for the prior art terms commonly used for this type of battery.

The term “chalcogenide” refers to an oxide, sulfide, selenide or telluride. The term also encompasses chemical compounds of one or more of the chalcogen elements of oxygen, sulfur, selenium and tellurium comprising one or more metals, transition metals, arsenic, germanium, phosphorus, antimony, boron, in particular lead, aluminum, gallium, indium or titanium.

The term “amorphous” refers to an X-ray diffraction diagram preferably exhibiting a wide scatter band with a peak at 2θ in a range of from 20 to 70° using CuKα radiation. The X-ray diffraction diagram can, however, have one or more diffraction lines attributed to crystalline structures. The maximum intensity of the crystalline diffraction line to then be observed at 2θ in the range of 20 to 70° preferably amounts to no more than 500-fold, more preferably no more than 100-fold, particularly no more than 5-fold of the intensity of the peak of the wide scatter band observed at 2θ in the range of 20 to 70°. Of highest preference is for no diffraction line attributable to a crystalline range to be observed. If identification by X-ray diffraction diagram proves ineffective, the amorphous character of the chalcogenide can also be confirmed by transmission electron microscopy, differential calorimetry or FTIR absorption spectra. The relevant methods are known to the expert. Prerequisite to the amorphous state is that when the chalcogenide is produced, the elements contained therein cannot be regularly arranged; i.e. crystallization is not allowed. Sintering processes are thus particularly well-suited to producing the amorphous chalcogenide. Chalcogenide can then also be amorphous when the elements contained therein are in a non-stoichiometric ratio. The term “vitreous” or “glassy” can also be used synonymously for the term “amorphous.”

The term “chalcogenide . . . able to conduct lithium ions” means that the chalcogenide conducts lithium ions during the electrochemical processes occurring in the battery. The term “transition metal” refers to the elements including their cations having the atomic numbers of 21 to 30, 39 to 48, 57 to 80 from the periodic table of the elements.

The term “crystalline” means that the maximum intensity of the crystalline diffraction line observed at 2θ in the range of 20 to 70° preferably amounts to more than 500-fold of the intensity of a peak of a wide scatter band at 2θ in the range of from 20 to 70°.

The term “fleece” refers to a planar structure made of fibers, particularly polymer fibers. By definition, the fibers are unwoven. The fleece is hence unwoven. The term “non-woven” is also used in place of the term “unwoven.” The relevant technical literature also uses terms such as “non-woven fabrics” or “non-woven material.” The term “non-woven material” is used synonymously with the term “non-wovens.” The term “non-woven material” is also used synonymously with terms such as “knit fabric” or “felt.”

The term “positive electrode” specifies the electrode of the battery which absorbs electrons upon discharging; i.e. when connected to an electrical load. Under the present conditions, this is the cathode.

The term “negative electrode” specifies the electrode of the battery which releases electrodes upon discharging; i.e. when connected to an electrical load. Under the present conditions, this is the anode.

### FIRST ASPECT OF THE INVENTION

A first aspect of the invention relates to a lithium ion battery which comprises:
(a) a positive electrode comprising at least one amorphous chalcogenide, preferably an oxide, which comprises lithium ions or which can conduct lithium ions;
(b) a negative electrode;
(c) a separator between the positive and the negative electrode, wherein the separator comprises a non-woven material composed of fibers;
(d) a non-aqueous electrolyte.

In one embodiment, the lithium ion battery is characterized by the amorphous oxide being selected from among a lithium phosphate; a lithium phosphate containing a transition metal; a mixed oxide of lithium oxide and one or more transition metal oxides; a transition metal oxide able to conduct lithium ions or a mixture of two or more thereof.

Producing the amorphous oxide is known or can occur pursuant known methods, for example via sintering with those applicable starting compounds resulting in amorphous oxide reacting with one another. The presence of an amorphous phase can be assessed in known manner as described above, for example by means of X-ray diffractometry or by dynamic differential scanning calorimetry (DSC).

Mixed oxides are preferably produced by the individual oxides reacting with one another, preferably by sintering. The individual elements are thereby preferably introduced in quantitative proportions which do not lead to the stoichiometric presence of the individual oxides in the mixed oxide.

In one preferential embodiment, the amorphous oxide is a lithium iron phosphate. Methods for producing amorphous lithium iron phosphates are known for example from the document specified in the prior art as well as from “Material Science-Poland, Vol. 27, No. 1, 2009 (The thermal stability, local structure and electrical properties of lithium-iron phosphate glasses).”

In one embodiment, the amorphous chalcogenide, preferably an oxide, can be used as such as the positive electrode.

In one embodiment, further materials are also present in the positive electrode such as e.g. binding agents or also further active materials and the amorphous oxide is provided as a coating on the positive electrode (a).

Such coatings can be produced pursuant known prior art methods. Known methods include for example applying the coating via screen printing, calendering, extrusion, spraying, chemical vapor deposition (CVD) or physical vapor deposition (PVD).

In one embodiment, apart from the amorphous oxide, the electrode comprises further elements able to support the electrochemical processes occurring within the battery.

In one embodiment, the lithium ion battery is characterized by the positive electrode (a) comprising, in addition to amorphous oxide: a crystalline oxide which comprises lithium ions or which can conduct lithium ions.

In one embodiment, the cathode (a) of the inventive battery preferably comprises a crystalline compound of the LiMPO₄ formula, whereby M is at least one transition metal cation of the elements of atomic numbers 21 to 30 from the periodic table of elements, wherein said transition metal cation is preferably selected from among the group consisting of Mn, Fe, Ni and Ti or a combination of said elements, and wherein the compound preferably exhibits an olivine structure, preferably a superordinate olivine, whereby Fe is particularly preferred. A lithium iron phosphate having an olivine structure of LiFePO₄ molecular formula can be used for the inventive lithium ion battery.

It is however also possible to use a lithium phosphate or a lithium iron phosphate containing an M element selected from among the group consisting of Mn, Cr, Co, Cu, Ni, V, Mo, Ti, Zn, Al, Ga, B and Nb. It is also further possible for the lithium phosphate or lithium iron phosphate to contain carbon for increasing conductivity.

In a further embodiment, the lithium iron phosphate of olivine structure used to produce the positive electrode exhibits the LiₓFe_{1-y}M_{y}PO₄ molecular formula, whereby M represents at least one element from the group consisting of Mn, Cr, Co, Cu, Ni, V, Mo, Ti, Zn, Al, Ga, B and Nb at 0.05≦x≦1.2 and 0≦y≦5 0.8.

In one embodiment, x=1 and y=0.

The positive electrode preferably contains the crystalline lithium phosphate or lithium iron phosphate as defined above in the form of nanocrystalline particles. The nanoparticles can take any given form; i.e. they can be more or less spherical or elongated.

In one embodiment, the lithium phosphate or lithium iron phosphate exhibits a measured D₉₅ particle size value of less than 15 μm. The particle size is preferably smaller than 10 μm.

In a further embodiment, the lithium phosphate or lithium iron phosphate exhibits a measured D₉₅ particle size value of between 0.005 μm to 10 μm.

In a further embodiment, the lithium phosphate or lithium iron phosphate exhibits a measured D₉₅ particle size value of less than 10 pm, wherein the D₅₀ value amounts to 4 μm±2 μm and the D₁₀ value is less than 1.5 μm.

The indicated values can be determined by measuring with static laser scattering (laser diffraction, laser diffractometry). These are known prior art methods.

In accordance with a preferred embodiment, the cathode can also comprise a lithium manganate, preferably LiMn₂O₄ of spinel type, a lithium cobaltate, preferably LiCoO₂, a lithium nickelate, preferably LiNiO₂, or a mixture of two or three of these oxides, or a lithium mixed oxide containing nickel, manganese and cobalt (NMC).

In a preferred embodiment, the cathode comprises at least one active material of a lithium-nickel-manganese-cobalt mixed oxide (NMC) not in a spinel structure in a mixture with a lithium manganese oxide (LMO) in spinel structure.

It is preferential for the active material to comprise at least 30 mol %, preferably 50 mol % NMC as well as concurrently at least 10 mol %, preferably at least 30 mol % LMO, in each case relative to the total number of moles of the cathodic electrode's active material (i.e. not relative to the cathodic electrode as a whole which, in addition to the active material, can also comprise conductive additives, binding agents, stabilizers, etc.).

It is preferential for the NMC and LMO together to constitute at least 60 mol % of the active material, further preferential is at least 70 mol %, further preferential is at least 80 mol %, further preferential is at least 90 mol %, in each case relative to the total number of moles of the cathodic electrode's active material (i.e. not relative to the cathodic electrode as a whole which, in addition to the active material, can also comprise conductive additives, binding agents, stabilizers, etc.).

There are in principle no restrictions relative the composition of the lithium-nickel-manganese-cobalt mixed oxide apart from the oxide needing to contain at least 5 mol %, preferentially at least 15 mol %, further preferentially at least 30 mol % each of nickel, manganese and cobalt in addition to lithium, in each case relative the total number of moles of the transition metal in the lithium-nickel-manganese-cobalt mixed oxide. The lithium-nickel-manganese-cobalt mixed oxide can be doped with any other metals, particularly transition metals, as long as the above-cited minimum molecular quantities of Ni, Mn and Co can be ensured.

A lithium-nickel-manganese-cobalt mixed oxide of the following stoichiometry is thereby particularly preferential: Li[Co_{1/3}Mn_{1/3}Ni_{1/3}]O₂, wherein the respective percentage of Li, Co, Mn, Ni and O can vary by +/−5 mol %.

The lithium phosphate or lithium iron phosphate used in the positive electrode (b), respectively the lithium oxide(s) as well as the materials used in general for the negative electrode (a), are held together by a binding agent adhering said materials on the electrode. Polymer binding agents can for example be used. Polyvinylidene fluoride, polyethylene oxide, polyethylene, polypropylene, polytetrafluorethylene, polyacrylate, ethylene-propylene-diene monomer copolymer (EPDM) and mixtures and copolymers thereof can preferably be used as binding agents.

In one embodiment, the lithium ion battery is also characterized by the crystalline oxide being selected from: a lithium manganate, a lithium nickelate, a lithium cobaltate or a mixed oxide of two or more of these oxides, a lithium iron phosphate.

The anode (b) of the inventive battery can be produced from a plurality of materials suitable for use in a battery with a lithium ion electrolyte. For example, the negative electrode can contain lithium metal or lithium in the form of an alloy, either as a film, a grid or as particles held together by an appropriate binding agent. The use of lithium metal oxides such as lithium titanium oxide is also possible. In principle, all materials which are able to form intercalation compounds with lithium can be used. Suitable materials for the negative electrode then include for example: graphite, synthetic graphite, carbon black, mesocarbon, doped carbon, fullerene, niobium pentoxide, tin alloys, titanium dioxide, stannic oxide and mixtures of these substances.

The separator (c) used for the battery has to be permeable to lithium ions in order to ensure ionic transport for lithium ions between the positive and the negative electrode. On the other hand, the separator needs to be non-conducting to electrons.

The separator of the inventive battery comprises a fleece of non-woven fibers, preferably non-woven polymer fibers. The non-woven material is preferably flexible and has a thickness of less than 30 μm. Methods for producing such non-woven material are known from the prior art.

The polymer fibers are preferably selected from among the group of polymers consisting of polyacrylonitrile, polyolefin, polyester, polyimide, polyetherimide, polysulfone, polyamide and polyether.

Suitable polyolefins, for example, are polyethylene, polypropylene, polytetrafluorethylene and polyvinylidene fluoride.

Polyethylene terephthalates are preferably preferential as polyesters.

In one preferential embodiment, the separator comprises a non-woven material which is coated with an inorganic material on one or both sides. The term “coating” also encompasses the ion-conducting inorganic material not only being coated on one or both sides of the non-woven material but also being within said non-woven material. The material used for the coating is preferably at least one compound from the group of oxides, phosphates, sulfates, titanates, silicates, aluminosilicates having at least one of the elements of zirconium, aluminum or lithium.

The ion-conducting inorganic material is preferably conductive to ions in a temperature range of from −40° C. to 200° C.; i.e. ion-conducting to the lithium ions.

In one preferred embodiment, the ion-conducting material comprises or consists of zirconium oxide.

Furthermore, a separator can be used which consists of a carrier at least partially permeable to material which is not conductive to electrons or only poorly conductive to electrons. This carrier is coated with an inorganic material on at least one side. An organic material realized as fibrous material is used for the carrier at least partially permeable to material. The organic material is structured in the form of polymer fibers, preferably polymer fibers of polyethylene terephthalate (PET). The fibrous material is coated with an ion-conducting inorganic material which is preferably conductive to ions in a temperature range of from −40° C. to 200° C. The inorganic ion-conducting material preferably comprises at least one compound from among the group of oxides, phosphates, sulfates, titanates, silicates, aluminosilicates having at least one of the elements of zirconium, aluminum or lithium, with zirconium oxide being particularly preferential. It is preferential for the inorganic ion-conducting material to comprise particles having a maximum diameter of less than 100 nm.

Such a separator is marketed in Germany by the Evonik AG company under the trade name of “Separion®” for example.

Methods for producing such separators are known in the prior art, for example from EP 1 017 476 B1, WO 2004/021477 and WO 2004/021499.

In principle, large pores and holes in separators used in secondary batteries can lead to internal short circuits. The battery can then discharge very quickly in a dangerous reaction. Large electric currents can thereby occur which, in the worst case scenario, can even cause a closed battery cell to explode. For this reason, the separator can play a crucial role in the safety or lack thereof of a high-performance or high-energy lithium battery.

Polymer separators generally prevent any current transport through an electrolyte as of a specific temperature (the so-called “shutdown temperature” of approximately 120° C.). This is due to that fact that at this temperature, the separator's pore structure breaks down and all the pores close up. Because no more ions can be transported, the dangerous reaction ensues which can lead to an explosion. If the cell continues to heat up due to external circumstances, however, the so-called “breakdown temperature” will be exceeded at approximately 150-180° C. As of this temperature, the separator will melt, whereby it contracts. There will then be direct contact between the two electrodes in many places within the battery cell and thus a large-surface internal short circuit. This causes the uncontrolled reaction which can end with an explosion of the cell, respectively the accumulated pressure needs to be dissipated by a pressure relief valve (a bursting disc), frequently while on fire.

In the case of the separator used in the inventive battery comprising a fibrous material of non-woven polymer fibers and the inorganic coating, a shutdown can only ensue when the substrate material melts due to the high temperature of the polymer structure and infiltrates into the pores of the inorganic material, thereby closing them. The separator, however, will not experience a breakdown as the inorganic particles ensure that the separator cannot melt completely. It is thus ensured that there are no operating conditions under which a large-surface short circuit can occur.

The type of fibrous material used exhibiting a particularly well suited combination of thickness and porosity allows the manufacturing of separators able to fulfill the requirements placed on separators for high-performance batteries, particularly high-performance lithium batteries. The simultaneous use of oxide particles precisely coordinated as to particle size to produce the porous (ceramic) coating realizes a particularly high porosity for the finished separator, whereby the pores are still sufficient small enough to prevent an unwanted growth of “lithium whiskers” through the separator.

Due to the high porosity of the separator, however, attention needs to be paid to ensuring that no dead spot forms in the pores.

Separators used for the invention also have the advantage that a portion of the anions of the conducting salt deposit on the inorganic surface of the separator material, which leads to improved dissociation and thus to better ion conductivity at high currents.

The separator used for the inventive battery, comprising a flexible fibrous material having a porous inorganic coating on and within said fibrous material, whereby the material of the fibrous material is selected from non-woven, non-electrically conductive polymer fibers, is also characterized by the fibrous material having a thickness of less than 30 μm, a porosity of more than 50%, preferably 50-97%, and a pore radius distribution in which at least 50% of the pores exhibit a pore radius of 75 to 150 μm.

It is particularly preferential for the separator to exhibit a fibrous material having a thickness of 5-30 μm, preferably 10-20 μm. Also particularly important is the most homogeneous possible pore radius distribution in the fibrous material as indicated above. In conjunction with optimally coordinated oxide particles of specific size, an even more homogeneous pore radius distribution in the fibrous material leads to optimum porosity for the separator.

The thickness of the substrate greatly influences the properties of the separator since not only the flexibility but also the surface resistance of the separator impregnated with electrolyte depends on the thickness of the substrate. Modest thickness results in a particularly low separator electrical resistance in application with electrolytes. The separator itself has a very high electrical resistance since it must have self-insulating properties. Thinner separators moreover allow increased packing density in a battery stack so that a larger amount of energy can be stored in the same volume.

The fibrous material preferably exhibits a porosity of 60 to 90%; 70 to 90% is particularly preferred. Porosity is thereby defined as the volume of the fibrous material (100%) minus the volume of the fibers of the fibrous material; i.e. the percentage of fibrous material volume not filled with material. The volume of the fibrous material can thereby be calculated from the dimensions of said fibrous material. The volume of the fibers results from the measured weight of the respective fibrous material and the density of the polymer fibers. The high porosity of the substrate also enables a higher porosity for the separator, which is why the separator can realize higher electrolyte absorption.

So as to realize a separator having insulating properties, same has preferably non-electrically conductive polymer fibers as defined above as the polymer fibers for its non-woven material, same being preferably selected from polyacrylonitrile (PAN), polyester such as e.g. polyethylene terephthalate (PET) and/or polyolefin (PO) such as e.g. polypropylene (PP) or polyethylene (PE), or mixtures of such polyolefins.

The polymer fibers of the fibrous material preferably exhibit a diameter of from 0.1 to 10 μm; 1 to 4 μm is particularly preferred.

Particularly preferential flexible fleeces exhibit a surface weight of less than 20 g/m², preferably from 5 to 10 g/m².

The separator comprises a porous, electrically insulating ceramic coating on and within the fleece. The porous inorganic coating on and within the fleece preferably exhibits oxide particles of the elements Li, Al, Si and/or Zr having a medium particle size of from 0.5 to 7 μm, preferentially of from 1 to 5 μm and particularly preferentially of from 1.5 to 3 μm. It is particularly preferential for the separator to comprise a porous inorganic coating on and within the fibrous material exhibiting aluminum oxide particles of a mean particle size of from 0.5 to 7 μm, preferentially of from 1 to 5 μm and particularly preferentially of from 1.5 to 3 μm which are bonded to an oxide of the Zr or Si element. In order to obtain the highest possible porosity, preferentially more than 50% by weight, and particularly preferentially more than 80% by weight, of all the particles fall within the above-cited limits of mean particle size. As already specified above, the maximum particle size preferably amounts to ⅓ to ⅕, and particularly preferentially less than or equal to 1/10 of the thickness of the fibrous material employed.

The separator preferably has a porosity of 30-80%, preferentially 40-75% and particularly preferentially 45-70%. Porosity hereby refers to the accessible, i.e. open, pores. The porosity can thereby be determined via the known mercury porosimetry methods or can be calculated from the volume and the density of the charge materials employed if it can be assumed that there are only open pores.

The separators used for the inventive battery are also characterized by being able to exhibit a tensile strength of at least 1 N/cm, preferably at least 3 N/cm and particularly preferential of from 3 to 10 N/cm. The separators can preferably be deflected to any radius down to 100 mm, preferably down to 50 mm and particularly preferentially down to 1 mm without damage. The separator's high tensile strength and good deflectability result in the advantage of the separator being able to take part in the changes occurring to the geometry of the electrodes during battery charging and discharging without it being damaged. The deflectability has the further advantage of commercially standardized coil cells being able to be produced with this separator. In such cells, the electrode/separator layers of standardized size are spirally wound together and contacting.

Preferential electrolytes (d) for the lithium ion batteries are non-aqueous and comprise an organic solvent as well as a lithium salt.

Preferential lithium salts have inert anions and are non-toxic. Suitable lithium salts are preferably lithium hexafluorophosphate, lithium hexafluoroarsenate, lithium bis(trifluoromethylsulfonyl) imide, lithium trifluoromethanesulfonate, lithium tris(trifluoromethylsulfonyl)methide, lithium tetrafluoroborate, lithium perchlorate, lithium tetrachloroaluminate, lithium chloride, lithium bis(oxalato)borate and mixtures thereof. In one embodiment, the lithium salt is selected from among LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₊₁)₂ or LiC(SO₂CₓF₂ₓ₊₁)₃ at 0≦x≦8, Li[(C₂O₄)₂13] and mixtures of two or more of these salts.

The electrolyte is preferably provided as an electrolyte solution. Suitable solvents are preferably inert. Suitable solvents include for example ethylene carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, cyclopentanone, sulfolane, dimethyl sulfoxide, 3-methyl-1,3-oxazolidine-2-one, γ-butyrolactone, 1,2-diethoxymethane, tetrahydrofuran, 2-methyltetrahydrofuran, 1,3-dioxolane, methyl acetate, ethyl acetate, nitromethane, 1,3-propansultone and mixtures of two or more of these solvents.

The electrolyte can comprise further additives customarily applicable to electrolytes for lithium ion batteries, including for example radical scavengers such as biphenyl, flame retarding additives such as organic phosphoric acid ester or hexamethylphosphoramide or acid scavengers such as amines. Electrolytes can likewise contain so-called overcharge additives such as cyclohexylbenzene.

Additives able to influence the formation of the “solid electrolyte interface” layer (SEI) on the electrodes, preferably electrodes containing carbon, can likewise be used in electrolytes. Vinylene carbonate is one such preferable additive.

In one embodiment, cooling means are provided in the battery. A cooling means is preferably a system of tubes which can be supplied with a liquid to discharge the heat arising for example when the battery is being charged.

### SECOND ASPECT OF THE INVENTION

A second aspect of the invention relates to a lithium ion battery which comprises:
(a) a positive electrode comprising sulfur and/or a lithium sulfide as well as at least one amorphous chalcogenide which comprises lithium ions or which can conduct lithium ions;
(b) a negative electrode comprising lithium metal or a lithium alloy;
(c) a separator between the positive and the negative electrode;
(d) a non-aqueous electrolyte.

The electrochemical reaction in the battery can be specified as follows:
(a) cathode: S₈+2Li⁺+e″→Li₂S₈; Li₂S₈→Li₂Sₙ+(8−n)S.
(b) anode: Li→Li⁺+e″;

The positive electrode (cathode (a)) preferably comprises a matrix of carbon in which the sulfur and/or the lithium sulfide is/are embedded.

In one embodiment, the positive electrode (cathode (a)) comprising a matrix of carbon in which the sulfur and/or the lithium sulfide is/are embedded is coated with the amorphous chalcogenide, preferably an oxide.

In a further embodiment, the negative electrode (anode (b)) comprises a lithium alloy. Suitable lithium alloys are preferably alloys of lithium and aluminum or tin or antimony, for example LiAl or Li₂₂Sn₅ or LiSb₃.

The lithium alloy is preferably embedded in a matrix of carbon. The positive electrode also preferably comprises a matrix of carbon in this embodiment.

In one embodiment, the negative electrode comprises an alloy of lithium and tin together with carbon. The electrochemical reaction during discharging can be specified as follows:
(a) anode: Li₂₂Sn₅+C→22Li⁺+5Sn/C+22e⁻;
(b) cathode: 11S+C+22Li⁺+22e⁻→11 Li₂S/C.

It is known that electrodes comprising metallic lithium or a lithium alloy can exhibit the property of expanding during charging and contracting during discharging. This can result in battery power loss. Using a lithium alloy in a carbon matrix allows advantageously compensating for the battery's volume changes.

In a further embodiment, the negative electrode comprises silicon wires, the dimensions of which are on the nanoscale. Using silicon as nanowire can likewise counter the unwanted volume change of the anode during charging/discharging. Negative electrodes comprising silicon nanowires are also known from rechargeable lithium ion batteries.

In a further embodiment, the silicon (in the form of nanowires) replaces the carbon in the anode.

The above-described separators can be used as the separator (c); i.e. separators based on a non-woven fibrous material. The lithium ion battery is accordingly characterized in this embodiment in that it comprises:
(a) a positive electrode comprising sulfur and/or a lithium sulfide as well as at least one amorphous chalcogenide which comprises lithium ions or which can conduct lithium ions;
(b) a negative electrode comprising lithium metal or a lithium alloy;
(c) a separator between the positive and the negative electrode, wherein the separator comprises a non-woven fibrous material;
(d) a non-aqueous electrolyte.

The fibers are preferably polymer fibers as defined in the first aspect of the invention.

Other separator systems as known in the prior art can also be employed, thus for example ceramic electrolyte separators or glass electrolyte separators not containing any liquid, or polymer electrolytes such as e.g. polyethers like polyethylene oxides. A polymer electrolyte can be used as a gel containing the organic liquids at a volume of approximately 20% by weight. It is likewise possible to make use of separator membranes; i.e. porous membranes which hold liquid electrolyte in small pores via capillary forces. The membranes preferably comprise polyolefins preferably such as polyethylene or polypropylene or a laminate of polyethylene and polypropylene.

In a further embodiment, the lithium ion battery comprises:
(a) a positive electrode comprising sulfur and/or a lithium sulfide as well as at least one amorphous chalcogenide, preferably an oxide, which comprises lithium ions or which can conduct lithium ions;
(b) a negative electrode comprising lithium metal or a lithium alloy;
(c) a separator between the positive and the negative electrode; wherein the separator comprises a porous membrane, a ceramic electrolyte separator, a glass electrolyte separator or a polymer electrolyte;
(d) a non-aqueous electrolyte.

The electrolyte (d) which can be used in the lithium-sulfur battery is a non-aqueous electrolyte, preferably an electrolyte as specified above in the first aspect of the invention.

Polysulfide anions are preferably added to the electrolyte of the lithium-sulfur battery, for example in the form of Li₂S₃, Li₂S₄, Li₂S₆, Li₂S₈. In one embodiment, the volume of added polysulfide is such that the electrolyte is saturated with polysulfide. This can thus counter the negative electrode's loss of sulfur. The addition of polysulfide preferably takes place prior to putting the battery into operation.

Manufacturing the battery

The lithium ion battery can be assembled from components (a) to (d) in accordance with methods known in the prior art and customarily used for manufacturing lithium ion batteries. In one embodiment, manufacturing is realized by lamination of the electrodes (a) and (b) to the separator (c) impregnated with the electrolyte (d). Methods for manufacturing the electrodes are likewise known from the prior art.

Application

The lithium-sulfur battery according to the invention can be used to supply energy to portable information apparatus, tools, electrically operated automobiles and hybrid drive automobiles.

The combination of the lithium ion-conducting separator and the amorphous chalcogenide, preferably an oxide, which comprises lithium ions or which can conduct lithium ions, has proven particularly advantageous in terms of the inventive battery's charging properties. This combination's good conductivity with respect to lithium ions achieves an advantageous charging rate for the battery. This makes such a battery of particular interest for electrically operated automobiles.

1. A lithium ion battery comprising:
(a) a positive electrode comprising at least one amorphous chalcogenide which comprises lithium ions or which can conduct lithium ions;
(b) a negative electrode;
(c) a separator between the positive and the negative electrode, wherein the separator comprises a non-woven material composed of fibers; and
(d) a non-aqueous electrolyte.

2. The lithium ion battery according to claim 1, wherein the chalcogenide is
a lithium-containing compound of one or more of the chalcogen elements of oxygen, sulfur, selenium and tellurium; or
a lithium-containing compound of one or more of the chalcogen elements of oxygen, sulfur, selenium and tellurium with one or more metals, transition metals, arsenic, germanium, phosphorus, antimony, boron, in particular lead, aluminum, gallium, indium, titanium; or
a compound of one or more of the chalcogen elements of oxygen, sulfur, selenium and tellurium with one or more metals, transition metals, arsenic, germanium, phosphorus, antimony, boron, in particular lead, aluminum, gallium, indium, titanium able to conduct lithium ions.

3. The lithium ion battery according to claim 1, wherein the elements contained in the amorphous chalcogenide are not in a stoichiometric ratio.

4. The lithium ion battery according to claim 1, wherein the chalcogenide is selected from a lithium phosphate; a lithium phosphate containing a transition metal; a mixed oxide of lithium oxide and one or more transition metal oxides; a transition metal oxide able to conduct lithium ions; or a mixture of two or more thereof.

5. The lithium ion battery according to claim 1, wherein the amorphous chalcogenide is provided as a coating on the positive electrode.

6. The lithium ion battery according to claim 1, wherein in addition to the amorphous chalcogenide, the positive electrode comprises a crystalline oxide comprising lithium ions or which can conduct lithium ions.

7. The lithium ion battery according to claim 6, the crystalline chalcogenide is selected from: lithium manganate, lithium nickelate, lithium cobaltate or a mixed oxide of two or more of these oxides; lithium iron phosphate.

8. The lithium ion battery according to claim 1, wherein the negative electrode comprises carbon and/or lithium titanate.

9. The lithium ion battery according to claim 1, wherein in addition to the amorphous chalcogenide, the positive electrode comprises sulfur and/or a lithium sulfide and the negative electrode comprises lithium metal or a lithium alloy.

10. The lithium ion battery according to claim 1, wherein the fibers are polymer fibers, preferably selected from among the group of polymers comprising polyester, polyolefin, polyamide, polyacrylonitrile, polyimide, polyetherimide, polysulfone, polyamidimide, polyether, polyphenylensulfide, aramid or mixtures of two or more of these polymers.

11. The lithium ion battery according to claim 10, wherein the polymer fibers comprise a polyethylene terephthalate.

12. The lithium ion battery according to claim 1, wherein a porous inorganic coating able to conduct lithium ions is provided in the non-woven material and/or on one or both sides of said non-woven material.

13. The lithium ion battery according to claim 1, wherein the separator (e) is composed of a carrier which is at least partially permeable to material and which does not conduct electrons or only poorly conducts electrons, wherein the carrier is coated on at least one side with an inorganic material, wherein an inorganic material is used as the carrier at least partially permeable to material which is formed as a non-woven fibrous material, wherein the inorganic material is in the form of polymer fibers, preferably polymer fibers of polyethylene terephthalate (PET), wherein the non-woven material is coated with an inorganic ion-conducting material which preferably conducts ions in a temperature range of from −40° C. to 200° C., wherein the inorganic ion-conducting material preferentially comprises a compound from the group comprising oxides, phosphates, sulfates, titanates, silicates, aluminosilicates having at least one of the elements of zirconium, aluminum, lithium, particularly preferentially zirconium oxide, wherein the inorganic ion-conducting material preferentially exhibits particles having a maximum diameter of less than 100 nm.

14. A lithium ion battery comprising:
(a) a positive electrode comprising sulfur and/or a lithium sulfide as well as at least one amorphous chalcogenide which comprises lithium ions or which can conduct lithium ions;
(b) a negative electrode comprising lithium metal or a lithium alloy;
(c) a separator between the positive and the negative electrode, wherein the separator comprises a porous membrane, a ceramic electrolyte separator, a glass electrolyte separator or a polymer electrolyte; and
(d) a non-aqueous electrolyte.

15. A method comprising:
using a lithium ion battery according to claim 1 to supply energy to portable information apparatus, tools, electrically operated automobiles and hybrid drive automobiles.
